(19) United States
(12) Patent Application Publication
(10) Pub. No.: US 2002/0035626 A1
(43) Pub. Date: Mar. 21, 2002

(54) Network management system

(76) Inventor: Yasushi Higuchi, Tokyo (JP)

Correspondence Address: McGuire Woods, Suite 1800, 1750 Tysons Boulevard, McLean, VA, 22102-4215, US

(21) Appl. No.: 09/954,153

(22) Filed: Sep. 18, 2001

(30) Foreign Application Priority Data
Sep. 21, 2000 (JP) 286571/2000

(51) Int. Cl. G06F 15/173

(52) U.S. Cl. 709/223

(57) ABSTRACT

A network management system, in which polling efficiency for simple network management protocol (SNMP) agents and performance of the network management system are adjustable, reusability of application is high, and its expanding capability is high, is provided. That is, a scalable network management system is provided. The network management system consists of an SNMP manager and plural SNMP agents, and the SNMP manager and the plural SNMP agents are connected through a network. The SNMP manager consists of a common object request broker architecture (CORBA)-SNMP gateway and a network management system (NMS) management module group. The SNMP manager communicates with the plural SNMP agents by using the SNMP, and the CORBA-SNMP gateway communicates with the NMS management module group by using the CORBA. Polling objects are provided in the CORBA-SNMP gateway, and the polling efficiency is adjusted and the performance of the network management system is prevented from deteriorating by adjusting the number of the polling objects.

### BACKGROUND OF THE INVENTION

The present invention relates to a network management system, in particular, which consists of a manager (management apparatus) that manages a network by using the simple network management protocol (SNMP) and agents that are connected to the manager through the network and managed by the manager.

### DESCRIPTION OF THE RELATED ART

The network management system manages physical objects (object resources) such as computers, communication apparatuses, terminal equipment, and communication channels, which are connected to a network, and also manages logical objects such as sessions, access, messages, and data, which are operated and/or used in communication. And with this, users can utilize the network in high integration and high efficiency.

Management items in the network management system are five items being trouble management, performance (function) management, security management, accounting management, and structure management.

At the trouble management, troubles in the network are detected and the troubles are taken out and causes of the troubles are removed, and then the normal state of the network is recovered. Therefore, the trouble management needs a trouble notifying function that immediately and automatically notifies an alarm to a center that is managing and monitoring the network, when some trouble occurs in the network, a trouble analyzing function that collects trouble data for distinguishing the trouble and analyzes the collected data, a test function that specifies the trouble position, and a trouble recovering function that recovers the trouble.

The performance (function) management monitors the operating state of the network, and collects data relating to performance (function) and quality (connecting state) of the network, and with this, a network having high efficiency and high reliability is offered.

The security management implements user authentication, access control, an audit to prevent the network from accessing from illegal access (hacker, worm, virus), when the network is connected to an external network and/or equipment.

The accounting management stores information of a using state of resources in the network, and implements charging management for users who use the network.

The structure management forms and changes the network, and makes the operation of the network smooth by totally managing the structure information. The resources of the network are hardware such as computers, communication apparatuses, terminal equipment, and communication channels, and logical setting such as logical paths, and routing. That is, the structure management controls the operation so that the structure change of the network does not influence other resources in the network by managing the structure change.

In order to make the network management efficient, utilizing the common object request broker architecture (CORBA) being one of computing platforms using at a distributed data processing is proposed.

This CORBA stipulates common architecture of the object request broker (ORB) being a function with which objects in the distributed data processing system exchange their messages each other.

And when the SNMP is used as a network management protocol, each of management objects that are handled is called a management information base (MIB).

However, at a conventional network management system using the SNMP, polling efficiency for each of agents and performance of resources in the network management system are made to cooperate. And a structure, in which a tradeoff between the polling efficiency and the performance of the resources in the network management system can be chosen, is not used.

Furthermore, at the conventional network management system, there is a problem that total performance of the network management system is lowered corresponding to that the number of SNMP agents to be monitored is increased and the polling efficiency is improved.

### SUMMARY OF THE INVENTION

It is therefore an object of the present invention to provide a network management system, in which polling efficiency for SNMP agents and performance of the network management system are adjustable, reusability of application is high, and its expanding capability is high. That is, a scalable network management system is provided.

According to a first aspect of the present invention, for achieving the object mentioned above, there is provided a network management system, which consists of a manager that manages a network by using the simple network management protocol (SNMP) and plural agents that are connected to the manager through the network and are managed by the manager. And the manager provides a gateway that communicates with the plural agents by using the SNMP, and a network management system (NMS) management module group that communicates with the gateway by using the common object request broker architecture (CORBA).

According to a second aspect of the present invention, in the first aspect, the gateway provides plural polling objects that transmit an SNMP Get Request periodically to each of management information bases (MIBs) that are defined in each of the plural agents.

According to a third aspect of the present invention, in the second aspect, some of the plural polling objects are appended or removed while the network management system is operating.

According to a fourth aspect of the present invention, in the second aspect, each of the plural polling objects provides an MIB iterator object that extracts an MIB object instance being an object for the SNMP Get Request one by one.

According to a fifth aspect of the present invention, in the first aspect, the NMS management module group provides one or more status change reception objects that receive the contents of status change of an MIB object instance judged by a polling object in the gateway from the gateway by using the CORBA for one polling object.

According to a sixth aspect of the present invention, in the fifth aspect, each of the plural polling objects is an instance of a class inheriting an abstract class installing a Subject interface class. And the Subject interface class provides an attach method for attaching the status change reception object, a detach method for detaching the status change reception object, a notify method for notifying the status change to the status change reception object when the polling object judged the status change, and a Get Status method that gets the contents of status change of the polling object.

According to a seventh aspect of the present invention, in the fourth aspect, each of the plural polling objects provides an append method for appending the MIB object instance to the MIB iterator object, and a remove method for removing the MIB object instance from the MIB iterator object.

According to an eighth aspect of the present invention, in the sixth aspect, the status change reception object is an instance of a class inheriting an abstract class installing an Observer interface. And the Observer interface provides an update method for renewing an attribute value of the MIB object instance, when the status change is notified from the polling object by the notify method.

According to a ninth aspect of the present invention, in the fourth aspect, the MIB iterator object provides a Next method for extracting the MIB object instances one by one.

According to a tenth aspect of the present invention, in the fourth aspect, the MIB object instance defines an MIB object ID and an attribute value of the MIB object ID as a class attribute, and provides an attribute get method and a renew method that renews a database in which the attribute value is storing.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a system structure of an embodiment of a network management system of the present invention;

FIG. 2 is a block diagram showing a detailed structure of an SNMP manager at the embodiment of the network management system of the present invention;

FIG. 3 is a diagram showing an operation example at the embodiment of the network management system of the present invention;

FIG. 4 is a diagram showing a first example using a polling object and an MIB iterator object at the embodiment of the network management system of the present invention;

FIG. 5 is a diagram showing a second example using the polling objects and the MIB iterator objects at the embodiment of the network management system of the present invention;

FIG. 6 is a diagram showing an operation mechanism between the polling object and a status change reception object at the embodiment of the network management system of the present invention;

FIG. 7 is a class diagram of the embodiment of the network management system of the present invention;

FIG. 8 is a diagram showing an MIB object instance at the embodiment of the network management system of the present invention;

FIG. 9 is a diagram showing an interface definition language (IDL) defining a CORBA interface between a polling object and a status change reception object; and

FIG. 10 is a class diagram at another embodiment of the network management system of the present invention.

### DESCRIPTION OF THE PREFERRED EMBODIMENTS

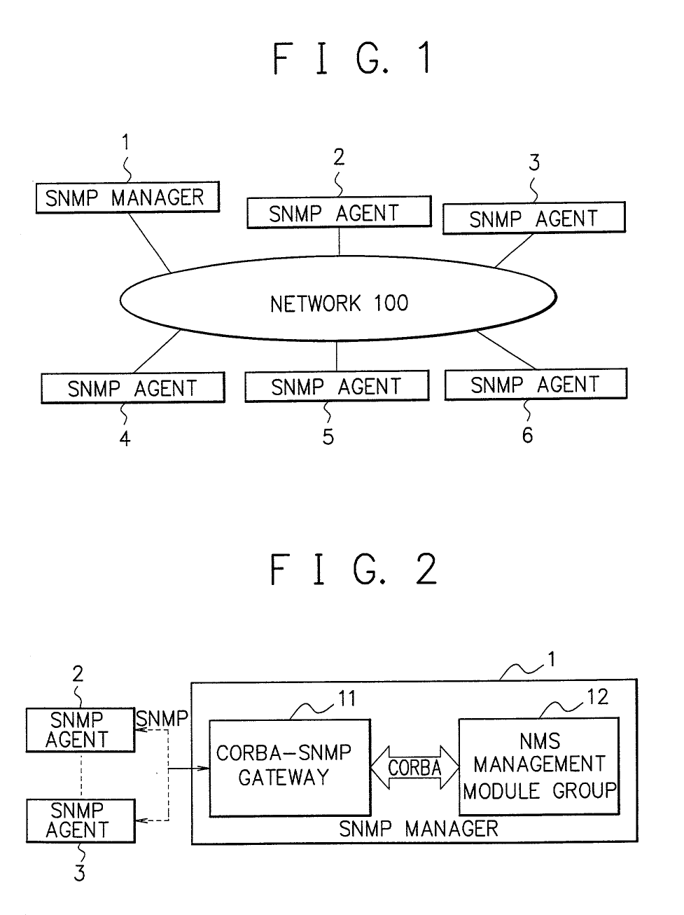

Referring now to the drawings, embodiments of the present invention are explained in detail. FIG. 1 is a block diagram showing a system structure of an embodiment of a network management system of the present invention. As shown in FIG. 1, the embodiment of the network management system of the present invention consists of an SNMP manager 1, plural SNMP agents 2 to 6, and a network 100 such as a WAN/LAN. And the SNMP manager 1 and the plural SNMP agents 2 to 6 are connected with the network 100. In this, the number of the plural SNMP agents 2 to 6 is five, however, this number is not limited to five and the number can be increased corresponding to the system structure.

The SNMP manager 1 is a management apparatus that grasps the status of the plural SNMP agents 2 to 6 (to be managed) and changes various kinds of setting of the plural SNMP agents 2 to 6.

The plural SNMP agents 2 to 6 are apparatuses whose operating status and the various kinds of setting are managed by the SNMP manager 1.

At the management mechanism by the SNMP, the SNMP manager 1 accesses various kinds of information called MIB that is held in each of the plural SNMP agents 2 to 6, and changes the operating status and definition (structure information) of each of the plural SNMP agents 2 to 6. In this mechanism, the SNMP manager 1 basically accesses each of the plural SNMP agents 2 to 6, however, in case that some trouble occurs in the plural SNMP agents 2 to 6, a trap function, which transmits information from the plural SNMP agents 2 to 6 to the SNMP manager 1, is provided.

FIG. 2 is a block diagram showing a detailed structure of the SNMP manager 1 at the embodiment of the network management system of the present invention. In FIG. 2, the SNMP manager 1 is connected to the SNMP agents 2 and 3, and the SNMP manager 1 consists of a CORBA-SNMP gateway 11 and a network management system (NMS) management module group 12.

The communication between the SNMP manager 1 and the SNMP agents 2 and 3 are implemented by the SNMP, and the communication between the CORBA-SNMP gateway 11 and the NMS management module group 12 is implemented by the CORBA. In this, as mentioned above, the CORBA is common architecture for that objects in the distributed data processing exchange their messages each other.

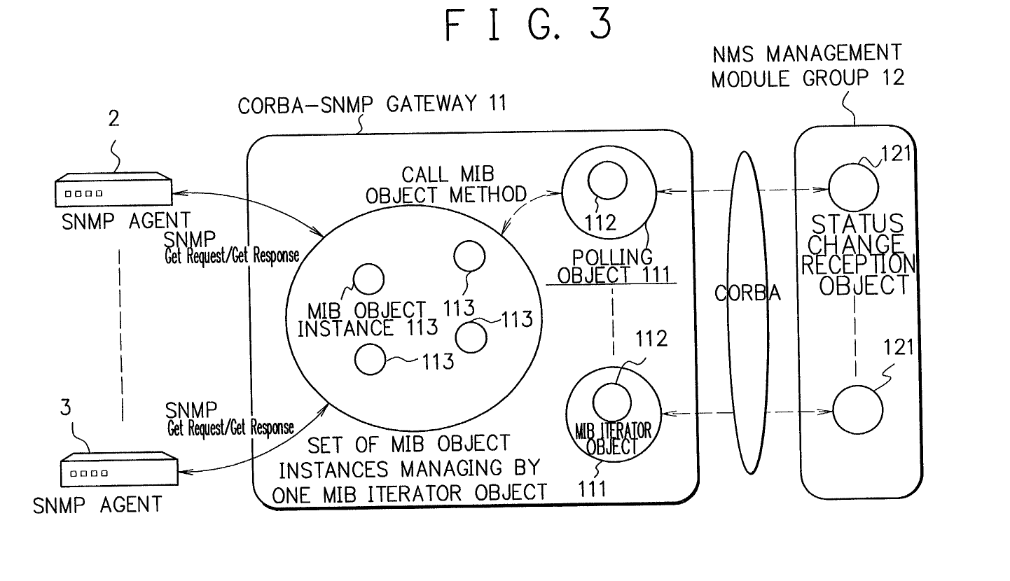

FIG. 3 is a diagram showing an operation example at the embodiment of the network management system of the present invention. In FIG. 3, the CORBA-SNMP gateway 11 provides plural polling objects 111 that periodically transmit an SNMP Get Request to an MIB being the management object defined at each of the SNMP agents 2 and 3.

The polling object 111 can be appended or removed during the operation of the network management system, therefore the number of the polling objects 111 are adjustable, therefore the system structure is flexible and scalable.

Each of the polling objects 111 has an MIB iterator object 112 that has a function to extract an MIB object instance 113, which is an object of the SNMP Get Request, one by one. And each of the polling objects does not manage the MIB object instance 113 directly.

In the NMS management module group 12, a status change reception object 121, which receives the contents of the status change of an MIB object instance 113 judged by the polling object 111, exists at least one or more for one polling object, and the CORBA-SNMP gateway 11 and the NMS management module group 12 communicate with each other by the CORBA.

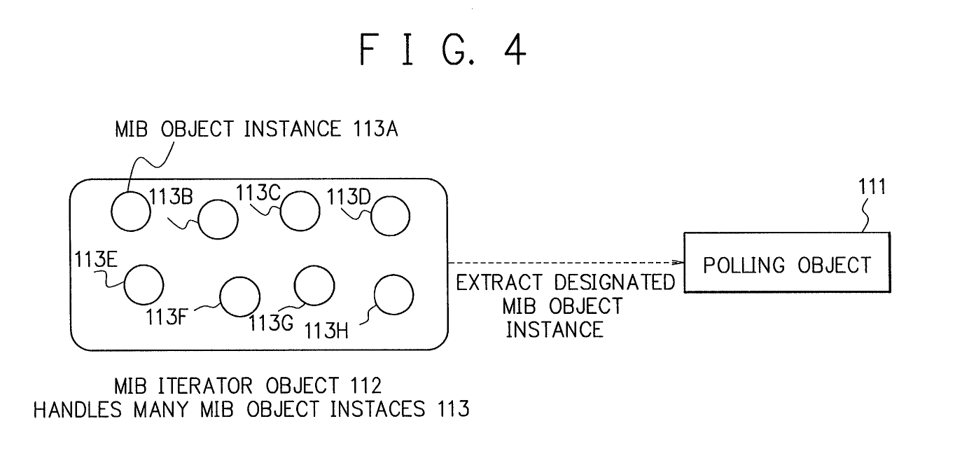

FIG. 4 is a diagram showing a first example using the polling object 111 and the MIB iterator object 112 at the embodiment of the network management system of the present invention. As shown in FIG. 4, the number of the MIB object instances 113 being managed by one MIB iterator object 112 is increased, and the number of the polling object 111 and the number of the MIB iterator object 112 is made to be one each. In this example, eight MIB object instances 113 A to H are managed by one MIB iterator object 112. As mentioned above, when a small number of the polling object 111 and a small number of the MIB iterator object 112 are used and a large number of the MIB object instances 113 are used, the load for the hardware of the network management system can be lowered.

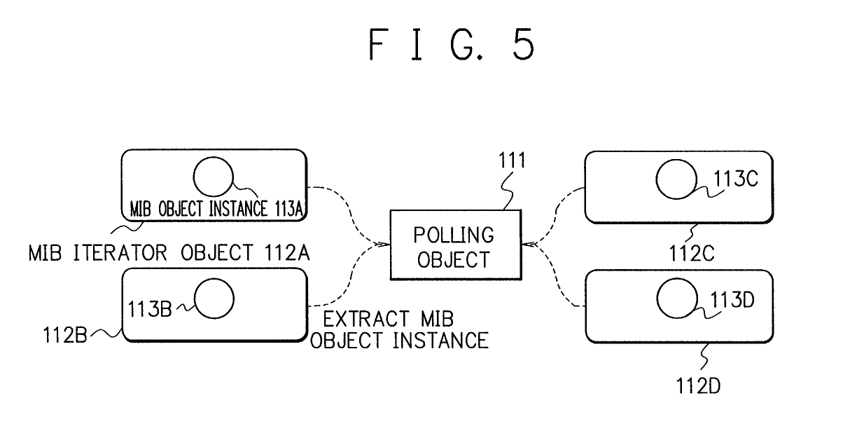

FIG. 5 is a diagram showing a second example using the polling objects 111 and the MIB iterator objects 112 at the embodiment of the network management system of the present invention. As shown in FIG. 5, each of the MIB iterator objects 112 A to D manages each of the MIB object instances 113 A to D respectively. That is, one MIB iterator object manages one MIB object instance. Therefore, the number of the polling objects 111 is made to be four. As mentioned above, when the number of the MIB object instances 113 being managed by one MIB iterator object 112 is decreased, the number of the polling objects 111 is increased. Therefore, the polling efficiency for each of the SNMP agents can be increased.

As mentioned above, at the embodiment of the network management system of the present invention, a tradeoff between the polling efficiency for each of the SNMP agents and the load for the hardware of the network management system can be chosen by that the number of the polling objects 111 is increased or decreased.

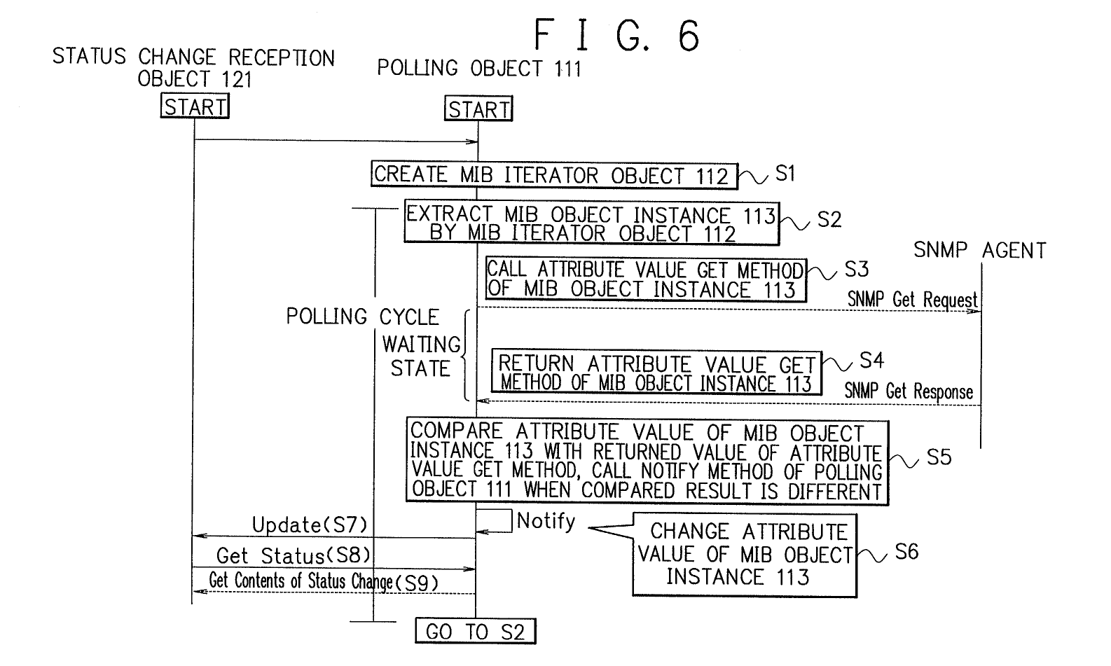

FIG. 6 is a diagram showing an operation mechanism between the polling object 111 and the status change reception object 121 at the embodiment of the network management system of the present invention. Referring to FIG. 6, the polling function implementing by the polling object 111, and the operation that the polling object 111 notifies the contents of change to the status change reception object 121 are explained.

First, the polling object 111 creates one MIB iterator object 112 (step S1), and a “Next method” for extracting the MIB object instance 113 is implemented by the created MIB iterator object 112 (step S2).

And an “attribute value get method” of the MIB object instance 113 extracted by the “Next method” is called and implemented (step S3), and the polling object 111 transmits an SNMP Get Request to a target SNMP agent.

When an SNMP Get Response being the response from the SNMP agent is transmitted from the SNMP agent, the MIB object instance 113 returns the contents of the SNMP Get Response as a returned value of the “attribute value get method” to the polling object 111 (step S4).

The polling object 111 becomes a waiting state during the period from calling to returning the “attribute value get method” of the MIB object instance 113. The polling object 111 compares the value of Object ID (attribute value) of the MIB object instance 113 storing in the network management system with the returned value of the “attribute value get method”, and when the compared result is different, the polling object 111 calls a “Notify method” of the polling object 111 (step S5).

At the “Notify method”, an “Update method” of the status change reception object 121 attaching to the polling object 111 is called (step S7), and also the attribute value of the MIB object instance 113 is changed (step S6).

At the “Update method” of the status change reception object 121, a “Get Status method” of the polling object 111, which is attached to the status change reception object 121, is called (step S8), and the contents of the status change of the polling object 111 is got (step S9).

The polling object 111 repeats the steps S2 to S8 cyclically, and realizes the polling processes for the SNMP agents.

And the polling object 111 can implement to append the MIB object instance 113, which the polling object 111 makes the MIB iteretor object 112 manage, by an “Append method”, and also can implement to remove the MIB object instance 113 by a “Remove method”.

The status change reception object 121 is holding object references, to which polling object 111 the status change reception object 121 is attached. And the “Get Status method” is called by the polling object 111 by that the status change reception object 121 calls its own “Update method” (the step S7), and the polling object 111 can get the status change of the polling object 111 (the step S8). With this, an asynchronous image communication can be realized.

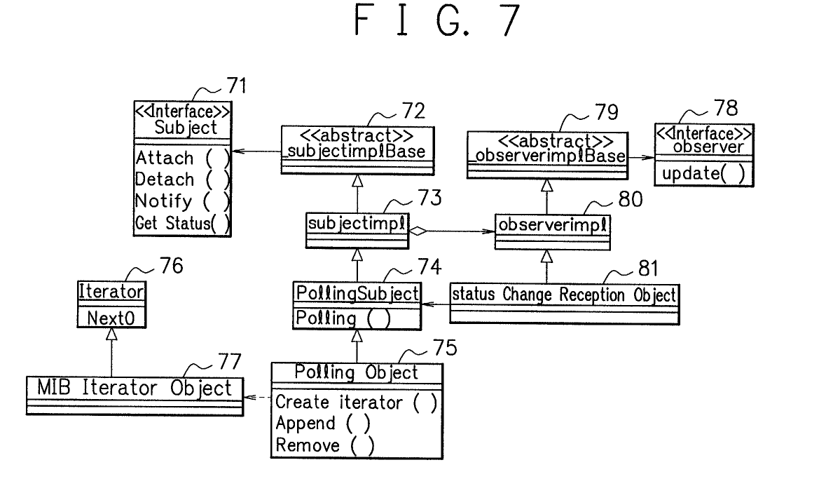

FIG. 7 is a class diagram of the embodiment of the network management system of the present invention. A polling object 75 extracts an MIB object instance one by one from an MIB iterator object 77, therefore, the polling object 75 does not relate to the MIB object instance directly. Consequently, even when the number of the MIB object instances, which are being managed by the MIB iterator object 77, increases or decreases, the application itself of the polling object 75 is not influenced from this increase or decrease.

Furthermore, the relation between the polling object 75 and the status change reception object 81 is not close, therefore the reusability of application can be improved.

In FIG. 7, the polling object 75 is an instance of a class 72 that inherits an abstract class installing a subject interface class 71 in which an attach method for attaching a status change reception object 81, a detach method for detaching the status change reception object 81, a notify method for notifying the status change to the status change reception object 81 when the status change is judged, and a Get Status method for getting the contents of the status change of the polling object 75 are provided. And the polling object 75 also provides an append method for appending the MIB object instance to the MIB iterator object 77 and a remove method for removing the MIB object instance from the MIB iterator object 77. The status change reception object 81 is an instance of a class that inherits an abstract class 79 installing an observer interface 78 that has an update method for changing the attribute value of the MIB object instance when the status change is notified from the polling object 75. The MIB iterator object 77 provides a Next method for extracting the MIB object instance one by one.

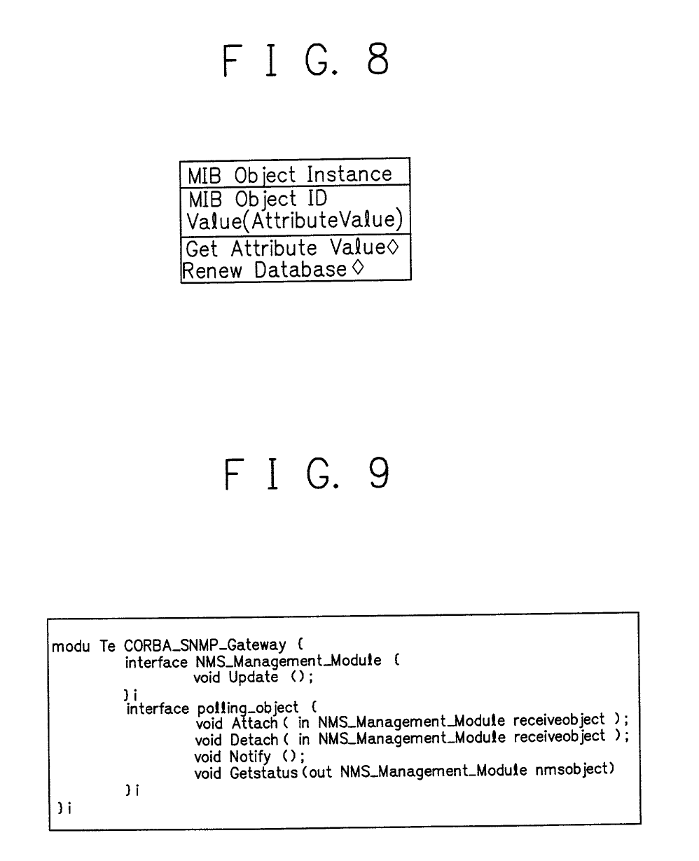

FIG. 8 is a diagram showing an MIB object instance at the embodiment of the network management system of the present invention. As shown in FIG. 8, the MIB object instance defines an attribute value “Value” of an MIB Object ID as a class attribute, and further defines an “attribute value get method” and a renew method of a database in which attribute values are stored as a class method. In this, the renew method changes the attribute value of the MIB object instance.

FIG. 9 is a diagram showing an interface definition language (IDL) defining a CORBA interface between a polling object and a status change reception object. With this, the CORBA interface is defined.

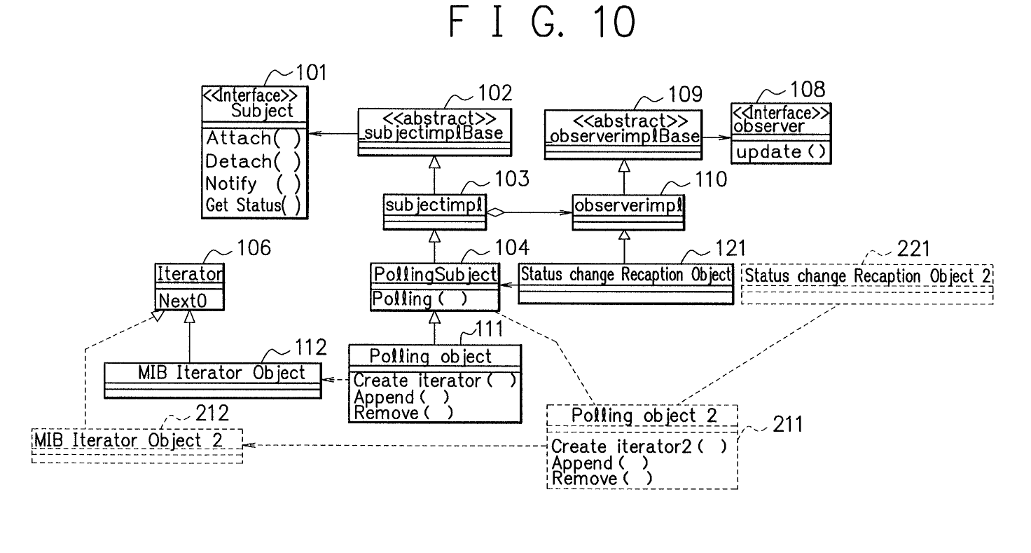

FIG. 10 is a class diagram at another embodiment of the network management system of the present invention. As shown in FIG. 10, at another embodiment of the network management system of the present invention, when an MIB iterator object 2 “212”, whose extracting method of an MIB object instance is different from the MIB iterator object 112, is added, the MIB iterator object 2 “212” can be added without changing the existing structure. That is, in addition to the MIB iterator object 2 “212”, a polling object 2 “211” and a status change reception object 2 “221” are newly added, and the existing structure having the polling object 111, the MIB iterator object 112, and the status change reception object 121 does not change.

As mentioned above, according to the embodiments of the network management system of the present invention, polling objects are provided in a CORBA-SNMP gateway, and the polling efficiency can be adjusted and the deterioration of the performance of the network management system can be prevented by adjusting the number of the polling objects.

And according to the network management system of the present invention, the reusability of the polling objects and the status change reception objects can be improved by that the dependent relation between the polling objects and the status change reception objects is decreased.

Moreover, according to the network management system of the present invention, the polling objects do not manage the set of the MIB object instances directly, and even when the set of the MIB objects instances is changed, the polling objects can correspond by changing the MIB interator objects, consequently the polling objects need not to be changed. Therefore, when the polling objects are installed, the reusability of classes and modules related to the polling objects can be improved.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A network management system, which consists of a manager that manages a network by using the simple network management protocol (SNMP) and plural agents that are connected to said manager through said network and are managed by said manager, wherein:
said manager, comprising:
a gateway that communicates with said plural agents by using said SNMP; and
a network management system (NMS) management module group that communicates with said gateway by using the common object request broker architecture (CORBA).

2. A network management system in accordance with claim 1, wherein:
said gateway, comprising:
plural polling objects that transmit an SNMP Get Request periodically to each of management information bases (MIBs) that are defined in each of said plural agents.

3. A network management system in accordance with claim 2, wherein:
some of said plural polling objects are appended or removed while said network management system is operating.

4. A network management system in accordance with claim 2, wherein:
each of said plural polling objects, comprising:
an MIB iterator object that extracts an MIB object instance being an object for said SNMP Get Request one by one.

5. A network management system in accordance with claim 1, wherein:
said NMS management module group, comprising:
one or more status change reception objects that receive the contents of status change of an MIB object instance judged by a polling object in said gateway from said gateway by using said CORBA for one polling object.

6. A network management system in accordance with claim 5, wherein:
each of said plural polling objects is an instance of a class inheriting an abstract class installing a Subject interface class, wherein:
said Subject interface class, comprising:
an attach method for attaching said status change reception object;
a detach method for detaching said status change reception object;
a notify method for notifying said status change to said status change reception object when said polling object judged said status change; and
a Get Status method that gets the contents of status change of said polling object.

7. A network management system in accordance with claim 4, wherein:
each of said plural polling objects, comprising:
an append method for appending said MIB object instance to said MIB iterator object; and
a remove method for removing said MIB object instance from said MIB iterator object.

8. A network management system in accordance with claim 6, wherein:
said status change reception object is an instance of a class inheriting an abstract class installing an Observer interface, wherein:
said Observer interface, comprising:
an update method for renewing an attribute value of said MIB object instance, when said status change is notified from said polling object by said notify method.

9. A network management system in accordance with claim 4, wherein:
said MIB iterator object, comprising:
a Next method for extracting said MIB object instances one by one.

10. A network management system in accordance with claim 4, wherein:
said MIB object instance defines an MIB object ID and an attribute value of said MIB object ID as a class attribute, and provides an attribute get method and a renew method that renews a database in which said attribute value is storing.
